(19) United States
(12) Patent Application Publication
(10) Pub. No.: US 2012/0286957 A1
(43) Pub. Date: Nov. 15, 2012

(54) Mobile Sleep Detection Method and System

(76) Inventors: Stephen Frechette, Newton, MA (US); Ross Simpson, Pembroke, MA (US); Joshua A. Grauman, Hinsdale, MA (US); Kevin Chavez, Stoneham, MA (US)

(21) Appl. No.: 13/471,428

(22) Filed: May 14, 2012

Related U.S. Application Data
(60) Provisional application No. 61/485,981, filed on May 13, 2011.

(51) Int. Cl. G08B 23/00

(52) U.S. Cl. 340/575

(57) ABSTRACT

The method and system of this invention is an improvement invention on a system that detects when an operator of a vehicle falls asleep, through the use of a digital video camera. The system is automatically disabled and no alarm sounds if the vehicle is not in motion.

### CROSS-REFERENCE TO RELATED APPLICATIONS

This application claims the benefit of U.S. Provisional Patent Application No. 61/485,981 filed on May 13, 2011, which is hereby incorporated herein by reference in its entirety.

### BACKGROUND OF THE INVENTION

1. Field of the Invention

This invention is an improvement on a product that solves the problem of determining when a vehicle operator is sleeping and then wakes up the operator up via an audible alarm.

The camera that observes the individual operates in at least one of the following spectrums: Infra-red (IR), Ultra Violet (UV), or visible light. The individual's face must be in the field of view of the camera. Using face detection software in conjunction with eye detection software, the eye area is processed to determine whether the eyes are open or not.

Drivers falling asleep while driving are a major problem. This invention is an improvement on existing camera-based sleep detection devices for vehicles. Often times false alarms occur while the vehicle is stopped and the operator's eyes are not recognized by the camera. This scenario is defined as a false alarm because the vehicle is not in motion, and thus the operator does not have to look forward with open eyes. If the vehicle operator's eyes close for a period of time, or the eyes are not looking towards the road while the vehicle is not moving, then an alarm does not need to be sounded. Often times these false alarms occur because the head and eyes are directed in another direction or the eyes are closed for a period of relaxation, while the vehicle is not in motion. For example when a vehicle comes to a stop, the operator may turn towards the back seat to address an issue with another occupant, or reach for an object. In order to decrease the amount of false alarms when the vehicle is stopped, a solution is needed to determine if the vehicle is in motion without the need for information from any of the vehicle's computers/microcontrollers.

Since most vehicles do not have camera-based sleep detection devices installed, many vehicles would benefit from a portable or mobile sleep detection unit. A portable means to determine when vehicle is not in motion and automatically disable the portable sleep detection alarm would be of great use, and this is the problem that needs to be solved.

2. Description of Prior Art

In prior art some methods of motion sensing within the vehicle's electronic equipment have been integrated with camera-based sleep detection devices.

U.S. Pat. No. 5,008,946 invents a system that can be employed to determine if a vehicle driver's eyes are open or closed. This patent application is an improvement on U.S. Pat. No. 5,293,427, which employs a camera to determine when a vehicle's operator falls asleep or becomes inattentive of the road after a predetermined period of time. Many existing patents provide algorithms for use with a camera and a processor to detect when a vehicle operator has fallen asleep, via imaging of their face, which includes U.S. Pat. No. 5,689,241.

### BRIEF SUMMARY OF THE INVENTION

An object of the invention is to overcome at least some of the drawbacks relating to the designs of prior art devices as discussed above.

The presented invention meets the above-described needs, in that it decreases the occurrence of false alarms due to an operator's eyes not being open and directed towards the road, or screen, while the vehicle is not in motion; and within a portable unit that does not require information from the vehicle's computers/microcontrollers.

None of these previously cited U.S. patents contain a means to determine if the vehicle is in motion without information from one or more of the vehicle's machines, which may include the vehicle's computers/microcontrollers. This invention improves existing camera-based vehicle operator sleep detection systems by providing a means to automatic disable the audible alarm via a decision based on information provided by a Global Positioning System (GPS) and/or an inertial measurement unit (IMU) sensor, without any information from one or more of one of the vehicles computers/microcontrollers.

Since this invention does not require information transmission between the vehicle and the sleep detection device, the invention is mobile and portable.

The invention could be employed to detect a sleeping driver, or anyone sleeping on the job; including but not limited to air traffic controllers, security guards, prison guards, remote vehicle operators, and train/rapid-transit operators.

The invention also has ability to determine if a vehicle operator is distracted, the system detects when the eyes of the individual are not open and looking where they should look, e.g., on the road or on a monitor/computer-screen. For example if the driver is operating a cell phone and has their eyes off the road, while the vehicle is in motion, for more than a threshold period of time, the alarm will sound.

This device differs from previous art or patents in that the movement detection mechanism 180 automatically disables the audio alarm and warning light when the vehicle is not in motion. Another invention embodiment is the described system encompassed within a mobile communication device with an imaging device, .i.e., a cellular phone with a built in camera, .e.g., camera phone. Modern smart cellular phones include GPS and/or IMU sensors. Therefore the entire improvement on the invention can be encompassed within a smart camera phone through the use of the following items encompassed within the smart phone: the GPS and IMU measurement mechanism to detect if the vehicle is in motion, a video camera, a processor for processing the images, a speaker/buzzer, a microphone, an LED, and a keypad.

In this invention the vehicle motion sensor is a separate motion sensor based on either a GPS or IMU, independent of any information provided by a vehicle's computers or microcontrollers. The IMU may be in the form of an electromechanical system or a Microelectromechanical System (MEMS).

In other aspects, the invention provides a system having features and advantages corresponding to those discussed above.

### BRIEF DESCRIPTION OF THE DRAWINGS

Having thus described the invention in general terms, reference will now be made to the accompanying drawings, which are not necessarily drawn to scale, and wherein:

FIG. 1 illustrates a block diagram of the hardware elements of the preferred embodiment of the presented invention.

FIG. 2 is a description of the algorithm that executes on the processor 110.

FIG. 3 details the sleep detection algorithm that executes on the processor 110.

### DETAILED DESCRIPTION OF THE INVENTION

The invention includes five algorithms that operate on a processor that attaches to a digital video camera. The camera may operate in the UV range, IR range, or visible light spectrum. The camera can be placed anywhere in which the operator's eyes are in view, including but not limited to the steering column, dashboard, or sunscreen visor.

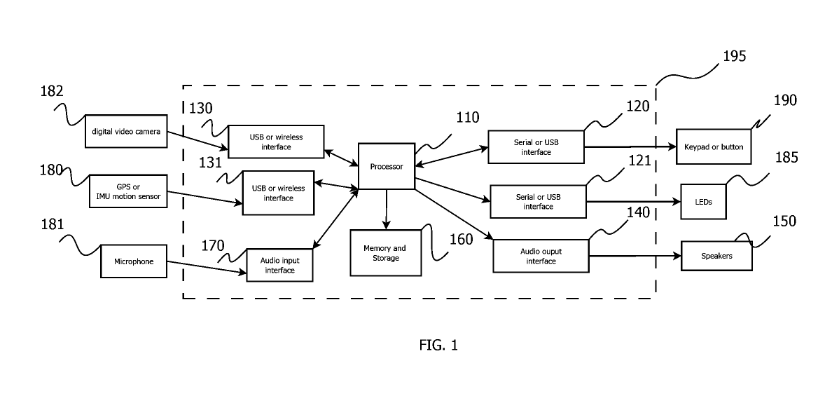

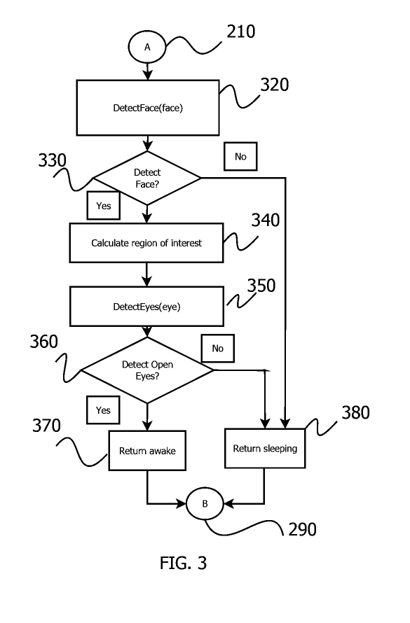

The system's hardware is illustrated in FIG. 1 System Hardware. The algorithm that operates on the processor 110, and communicates with the input/output devices is provided in FIGS. 3 and 4.

FIG. 1 illustrates a block diagram of the elements of the preferred embodiment of the presented invention. The core electronic components are housed within 195, which comprise the Processor 110, memory 160, and bus/communication elements 130, 131,170, 120, 121, and 140. The elements include a digital video camera 182 that connects to a wired or wireless video input interface 130, e.g., USB interface. A microphone for input of audio signals from an operator 181 connects to the audio input interface 170. A GPS or IMU based motion sensor system 180 connects to an input/output interface 131. All input and output devices, in addition to memory 160, connect to a main processor 110. The alarm can be disabled by a key press on a keypad or button in 190, via 120. Light-emitting diodes (LEDs) 185, are also activated when the audible alarm sounds, which are connected to 121.

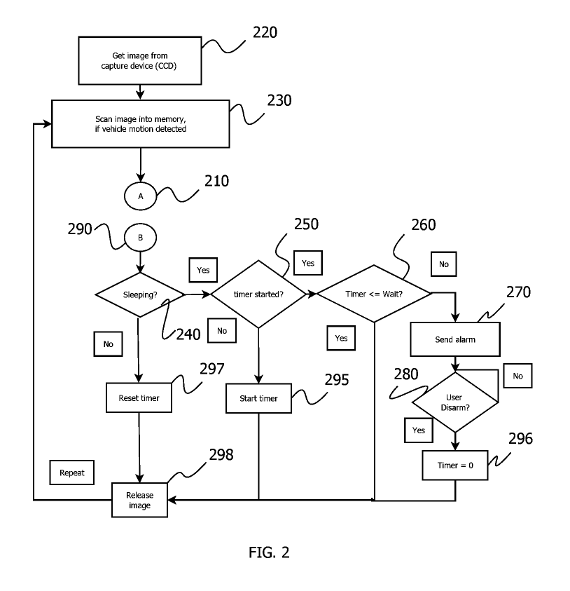

FIG. 2 provides a high level description of the main program that operates on the processor 110. 220 receives the input image from 182, and stores the image in memory 160 if motion is not detected in 180. The image is passed to A 210 in FIG. 3, for operation of a sleep detection algorithm via image processing. The output of FIG. 3, is a message of either awake or sleeping in 290. If awake is returned then 240 disables the timer 297 then releases the image 298. Next the algorithm returns to 230. If sleeping is returned from 290 in FIG. 3 then the timer started test is conducted 250, if a timer is not currently counting, then a timer is started in 295 and another image is collected for analysis in 230. If the timer has previously been started then a waiting time is checked in 260. If the counter of the timer is less than or equal to a preset wait time, then an alarm signal 270 is sent to speaker(s) 150. The alarm continues to sound the speaker(s) 150 and light the LEDs 185 until the user depresses button(s) 190, or optionally, a voice command is received via the microphone 181. If the alarm is disarmed by the user by pressing 190, then the timer counter is reset, in 296, and the process is repeated.

FIG. 3 provides a high level description of the sleep detection algorithm. 210 maps to FIG. 2, 320 detects the face and 330. The eye region of interests is determined in 340, and the eye detection method is illustrated in 350. If open eyes are detected in 360 then a return awake message 370 is passed to FIG. 2 via 290, else a sleep message is returned 380 via 290.

The invention's process of detecting when an individual is sleeping, and then waking them via an alarm, which they must deactivate, is illustrated in FIG. 2 System Steps. The software on the machine/computer includes the following multithreaded algorithms, in which all variables are global: Main Controller algorithm, Analyze Image algorithm, DetectFace algorithm, Set Region of Interest, and a DetectEyes algorithm.

The C++ source code that implements FIGS. 2 and 3 is provided in the computer program listing.

Through the use of the open source OpenCV image processing C/C++ library, much of the computer program listings, which employ the library, also can be compiled on a mobile/cellular camera phone's operating systems, e.g., iOS on an iPhone.

Another embodiment of the invention is that the processor may send a stop audio output/alarm signal to the speakers when the vehicle operator opens their eyes.

The following computer listing for the software is in the form of C++ source code, executes on 110, and is arranged by file name.

The file driver.h follows, in the form of C++ source code.

```
/* driver.h */
#ifdef _WIN32
#include <stdio.h>
#include <stdlib.h>
#include <conio.h>
#include <windows.h>
#include <winbase.h>
#include <iostream>
using namespace std;
#ifndef DRIVER_CODE_H
#define DRIVER_CODE_H
class ALARM {
public:
  //Class constructor. Initiallizes the port.
  ALARM( ) {
  int Error; int done = 1; Port_Change = 0;
  SerialPort = CreateFile(TEXT(“COM1”), GENERIC_READ |
  GENERIC_WRITE, 0, NULL, OPEN_EXISTING,
  FILE_ATTRIBUTE_NORMAL, 0);
  if (SerialPort==INVALID_HANDLE_VALUE)
  { Error=GetLastError( );
    printf(“error opening serial port!
    :-(\nError code: %i\nPress any key to exit...\n”, Error);
    _getch( ); }
  }
  int set_alarm( ) {
  if(EscapeCommFunction(SerialPort,SETDTR)) //Set the DTR pin
    return 1; else return 0; }
  void get_disarm( ) {
  SetCommMask(SerialPort,0);//Clr the comm mask,
  SetCommMask(SerialPort,EV_DSR);//look for a change in the CTS pin
  WaitCommEvent(SerialPort, &Port_Change, NULL);//run
  WaitCommEvent
  EscapeCommFunction(SerialPort,CLRDTR); //Clear the DTR pin
  }
private:
  HANDLE SerialPort; DWORD Port_Change;
};
#endif
#else
/************** linux code here ******************/
#include <iostream>
using namespace std;
class ALARM {
public:
  //Class constructor. Initiallizes the port.
  ALARM( )
  { }
  int set_alarm( )
  { cout << “ Alarm ” << endl; }
  void get_disarm( )
  { cout << “press y to :”; cin >> y;
    while (y!=‘y’)
  { cout << “press y to:”;
    cin >> y; }
  cout << “ y pressed ” << endl; }
private:
  char y;
};
#endif
```

The file sleepfinder.h follows, in the form of C++ source code.

```
/* sleepfinder.h */
#include <iostream>
#include “cv.h”
#include “highgui.h”
#include “cxcore.h”
#include “cvaux.h”
using namespace std;
#define WIN true
#define NOWIN false
#define SLEEPING true
#define AWAKE false
#define EXPAND 20
#define SCALE_HEIGHT 1.9
#define SCALE_SHIFT 3.0/2
class FINDSLEEP {
public:
  FINDSLEEP( );
  bool analyse( ); void window( ); void saveimg(const char* name);
private:
  bool featureExtract(IplImage *img);
  void camShiftSet(CvRect *face_r);
  IplImage* camShift(IplImage *cimg);
  /* cham shift and window flags */
  bool camloc,shift,win;
  /* classifier pointers */
  CvHaarClassifierCascade* eye; CvHaarClassifierCascade* face;
  CvCapture* capture; /* captuer pointer */
  CvMemStorage* storage; CvRect r; /* memory pointer */
};
```

The file sleepfinder.cpp follows, in the form of C++ source code.

```
/* sleepfinder.cpp */
#include “sleepfinder.h”
FINDSLEEP:FINDSLEEP( ) {
  storage=cvCreateMemStorage(0); /* create memory space */
  /* Open classifiers */
  face = (CvHaarClassifierCascade*)
  cvLoad(“haarcascade_frontalface_default.xml”,0,0,0);;
  eye=(CvHaarClassifierCascade*) cvLoad(“haarcascade_eye.xml”,0,0,0);
  capture = cvCaptureFromCAM(0); /* open any camera device */
  assert(storage && face && eye && capture); /* make sure all opens*/
  /* defaults */
  win=NOWIN; camloc=false; shift=false; r=cvRect(0,0,0,0);
}
/** Function analyse, takes no arguments and doesn't return anything
  * Gets a picture,searches for face,then eyes within the area of any
  * face it finds and stores it in a private data struct
  */
bool FINDSLEEP::analyse( )
  CvSeq *faces,*eyes; /* haar detect sequence results */
  CvRect *face_r,*eye_r; /* Rectangle pointer */
  IplImage *img,*camImage; /*image pointer */
  bool eyeFound=false; /* reset flag before using */
  /* Grab a Frame from the camera a few times to get recent image */
  //for (int i;i<3;i++)
  cvGrabFrame( capture );
  img=cvRetrieveFrame( capture );
  //cpy cam img to working img pointer use cam_r if
  //setimg=camShift(camImage); /*** unused since camshift broken ***/
  /* detect faces */
  faces = cvHaarDetectObjects(img, face, storage, 1.1,
  3, 0, cvSize( 40, 40 ) );
  cvClearMemStorage(storage);//reset buffer for the next object
  if (faces->total==0) return SLEEPING;
  cout << “Found ” << faces->total << “ faces” << endl;
  for(int face_n = 0; face_n < (faces->total); face_n++) {
  /* Create region of interest of faces found */
  face_r = (CvRect*)cvGetSeqElem( faces, face_n );
  if (face_r->height > 25 || face_r->height < 60) {
    cvRectangle(img, cvPoint(face_r->x, face_r->y +
    face_r->height/SCALE_SHIFT),
    cvPoint(face_r->x + face_r->width, face_r->y +
    face_r->height/SCALE_HEIGHT ), CV_RGB(0, 255, 0), 1, 8, 0);
  /* reset Region of Interest*/
  cvSetImageROI(img,cvRect(face_r->x, face_r->y
    + face_r->height/SCALE_SHIFT,face_r->width,
    face_r->height/SCALE_HEIGHT));
  /* detect eyes */
  eyes = cvHaarDetectObjects(img, eye, storage, 1.1,
      3, 0, cvSize( 25 , 25 ) );
  /* reset buffer for the next object detection */
  cvClearMemStorage(storage);
  if (eyes->total > 1) {
    eyeFound=true;
    cout << “Found ”<< eyes->total << “ eyes” << endl;
    camShiftSet(face_r);
    /* If window up */
    if(win==WIN)
    /*draw the eyes */
    for(int eye_n = 0; eye_n < (eyes->total) ; eye_n++) {
      eye_r = (CvRect*)cvGetSeqElem( eyes, eye_n );
      cvRectangle(img, cvPoint(eye_r->x, eye_r->y),
      cvPoint(eye_r->x + eye_r->width, eye_r->y +
      eye_r->height), CV_RGB(255, 0, 0), 1, 8, 0);
    }
  }
  featureExtract(img);
  cvResetImageROI(img); /*clear ROI for next face */
  }
}
if(win==WIN) {
  cvShowImage(“win”,img); /* show the image */
  cvWaitKey(20);
  }
  /************************************
  cvReleaseImage(&img);
  *** Unused since camshift broken ***/
  if(eyeFound==true) return AWAKE; else return SLEEPING;
}
/* if you want a window, will initilize it */
void FINDSLEEP::window( ) {
  cvNamedWindow( “win”, CV_WINDOW_AUTOSIZE );
  win=WIN;
}
/*attempt to find features of eyes*/
bool FINDSLEEP::featureExtract(IplImage *img) {
  // extract eye features here
  return true; //for now
}
void FINDSLEEP::camShiftSet(CvRect *face_r)
{
  // only set camloc if it hasn't been set yet
  if (camloc==false) {
  if (shift==true) { r.x=face_r->x + r.x;
    r.y=face_r->y + r.y; }
  else {
    r.x=face_r->x;
    r.y=face_r->y; }
  //expand the region by EXPAND points in all directions
  r.x=r.x − EXPAND;
  r.width=r.width + EXPAND;
  r.y=r.y − EXPAND;
  r.height=r.height + EXPAND;
  camloc=true; }
}
IplImage* FINDSLEEP::camShift(IplImage *cimg)
{
  bool roi=false;
  IplImage *img;
  //shift cam if coordinates set
  if (camloc==true) {
  camloc=false;
  shift=true;
  // double check boudaries for cimg
  if (r.x <0) r.x=0;
  if (r.y <0) r.y=0;
  if (r.height > cimg->height) r.height = cimg->height;
  if (r.width > cimg->width) r.width = cimg->width;
  // set the ROI of area of face found
  cvSetImageROI(cimg,r);
  roi=true; }
  else {
  //set the shift to false so if cam sets
  //it won't adjust
  shift = false; }
  // create new image the size of camera img
  img = cvCreateImage(cvGetSize(cimg), cimg->depth, cimg->nChannels);
  assert(img);
  cvCopy(cimg, img, NULL); // copy the image
  if (roi) cvResetImageROI(cimg); // if area of interest set reset it
  return img;
}
```

The file sleepmain.cpp follows, in the form of C++ source code.

```
/* sleepmain.cpp */
#include <iostream>
#include <time.h>
#include “sleepfinder.h”
#include “driver.h”
#define TIME 2
#define TEST 1
#define NOTEST 2
#define FRAMES 50
int main(void){
  time_t newtime,oldtime; time_t timer=false; int found=0;
  FINDSLEEP sleepy; ALARM alarmclass;
  char window = ‘e’; char test = ‘e’; int type;
  while (1) {
  cout << “do you want a window y or n:” << endl;
  cin >> window;
  if (window==‘y’){
    sleepy.window( );
    break;}
  if (window == ‘n’) break;
  }
  while (1) {
  cout << “do you want to run test code y or n:” << endl;
  cin >> test;
  if (test==‘y’){
    type=TEST;
    break; }
  if (test==‘n’){
    type=NOTEST;
    break;}
  }
  oldtime=time(NULL);
  /* test code, will track images/sec, accuracy and save the images */
  if (type==TEST) {
  for (int i=0;i<FRAMES;i++) {
    if(sleepy.analyse( ) == AWAKE) {
    found++;
    cout << “AWAKE” << endl; }
  }
  newtime=time(NULL);
  cout << “ Frames: ”<< FRAMES << “ Time: ”<< newtime-oldtime
  << “ FPS: ” << FRAMES/(float(newtime-oldtime)) << “ acc: ”
  << 100*found/FRAMES << endl;
  }
/*** Normal code with driver **/
  else{
  for(;;) {
    if (sleepy.analyse( )==SLEEPING) {
    if(timer==false) timer = time(NULL);
    else if (time(NULL)-timer>TIME) {
      if(alarmclass.set_alarm( )) {
      cout << “alarm set” << endl;
      alarmclass.get_disarm( );
      cout << “alarm disarmed” << endl;
      timer=false;
      }
      else
      cout << “Problem with setting alarm.” << endl;
    }
    }
    else {
  timer=false; }
    }
  }
  return 0;
}
```

What is claimed is:

1. Conventional and known machine/vehicle operator sleep detectors; wherein the improvement comprises the following steps:
an automatic prevention of activation of the audible alarm of a vehicle operator sleep detection system if the vehicle is not in motion as determined by components that do not receive any information from the vehicle's electronics;
an automatic deactivation of the audible alarm of a vehicle operator sleep detection system if the vehicle ceases motion as determined by components that do not receive any information from the vehicle's electronics.

2. The method according to claim 1, wherein the improvement comprises the step of sensing no motion, and prevents alarm activation.

3. The method according to claim 1, wherein the improvement comprises the step of sensing motion via an Inertial Measurement Unite (IMU) motion sensing mechanism 180 that automatically prevents alarm activation while the vehicle is not in motion.

4. The method according to claim 1, wherein the improvement comprises the step of sensing motion via an inertial-based electromechanical motion sensing mechanism 180 that automatically prevents alarm activation while the vehicle is not in motion.

5. The method according to claim 1, wherein the improvement comprises the step of sensing motion via a Global Positioning System (GPS) based motion sensing mechanism 180 that automatically prevents alarm activation while the vehicle is not in motion.

6. The method according to claim 1, wherein the entire system is encompassed within a mobile communication terminal, i.e., cellular camera-phone that contains the following:
a digital video camera,
a speaker or ringer or buzzer,
wherein the improvement comprises the following step:
a motion sensing mechanism, whether IMU-based or GPS-based, automatically prevents alarm activation while the vehicle is not in motion.

7. The computer program product according to claim 1, wherein the computer readable software instructions that are capable of detection of a sleeping driver; wherein the improvement comprises the following step:
the mechanisms for the sensing of motion and automatic prevention of alarm activation, while the vehicle is not in motion, are fully encompassed within a mobile device.
